(19) United States
(12) Patent Application Publication
(10) Pub. No.: US 2004/0010421 A1
(43) Pub. Date: Jan. 15, 2004

(54) Method and system for providing user specific information via a communications network

(76) Inventors: Teri W. Mina, Gurnee, IL (US); Michelle Robinette-Das, Griffith, IN (US); Jules Korzeniowski, Morristown, NJ (US); Kevin Drayton, Trenton, NJ (US); Andrew Baczynskyj, Wayne, NJ (US); Jack W. Henderson JR., Wheaton, IL (US)

Correspondence Address: BAXTER HEALTHCARE CORPORATION, RENAL DIVISION, 1 BAXTER PARKWAY, DF3-3E, DEERFIELD, IL, 60015, US

(21) Appl. No.: 10/400,727

(22) Filed: Mar. 27, 2003

Related U.S. Application Data
(63) Continuation of application No. 09/504,033, filed on Feb. 14, 2000, now abandoned.

(51) Int. Cl. G06F 17/60

(52) U.S. Cl. 705/2

(57) ABSTRACT

An method and system for providing a user of a client system with specific requested information from a server system. The server system has a plurality of tracks with each track having a plurality of documents relating to a specific stage of a medical condition. The client system has a browser and an identifier of one of the tracks. The client system sends the identifier to the server system and, in response to receiving the identifier, the server system sends to the client system the documents within the track identified by the identifier.

### TECHNICAL FIELD

The present invention relates to a computer method and system for providing user specific information, and in particular to a method and system for providing user specific information over the Internet.

### BACKGROUND OF THE INVENTION

The Internet comprises a vast number of computers and computer networks that are interconnected through communication links. The interconnected computers exchange information using various services, such as electronic mail, Gopher, and the World Wide Web (“WWW”). The WWW service allows a server computer system (i.e., Web server or Web site) to send graphical Web pages of information to a remote client computer system. The remote client computer system can then display the Web pages on a display screen such as a cathode ray tube (“CRT”) or the like. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages on a display screen.

Currently, Web pages are typically defined using HyperText Markup Language (“HTML”). HTML provides a standard set of tags that define how a Web page is to be displayed. When a user indicates to the browser to display a Web page, the browser sends a request to the server computer system to transfer to the client computer system an HTML document that defines the Web page. When the requested HTML document is received by the client computer system, the browser displays the Web page as defined by the HTML document. The HTML document contains various tags that control the displaying of text, graphics, controls, and other features. The HTML document may contain URLs of other Web pages available on that server computer system or other server computer systems.

An important feature of the WWW is the ability to connect one Web page to many other Web pages using “hypertext” links. A link typically appears unobtrusively as an underlined portion of text in a Web page; when the user of this page moves a pointer over the underlined text and clicks, the link—which is otherwise invisible to the user—is executed and the linked Web page is retrieved. It also is not necessary for the retrieved Web page to be located on the same server as the original Web page.

One of the benefits of the WWW is the accessability of information. Nevertheless, often times it is difficult for medical patients, friends, family members and anyone else who is interested in specific serious health problems to find concise and unbiased educational information on the Internet.

Accordingly, there is a need for providing educational information on specific serious health problems for the purpose of driving informed choice. Although not meant to replace direct communication with a physician, such information can complement or reinforce recommendations.

For example, there is a need for providing Internet access to information on basic kidney function, conditions which may lead to kidney disease, and the choices available to patients. Additional information needed may include psychosocial issues and financial concerns with insurance and reimbursement. Also, there is a need for insightful thoughts and useful advice from kidney patients and professionals. However, to assist patients wanting to find information about their current medical condition regarding a disease, there is a need to provide such patients with information that is currently relevant to the patient, while omitting other information regarding the disease that is not currently very useful to the patient.

### SUMMARY OF THE INVENTION

The present invention provides a method and system for providing a user with specific requested information.

The present invention includes providing a server system and a client system. The server system has a plurality of tracks with each track having a plurality of documents relating to a specific stage of a medical condition. The client system has a browser and an identifier of one of the tracks. The client system sends the identifier to the server system and, in response to receiving the identifier, the server system sends to the client system the documents within the track identified by the identifier.

Other advantages and features of the present invention will be apparent from the following description of a specific embodiment illustrated in the accompanying drawings.

### BRIEF DESCRIPTION OF THE DRAWINGS

FIG. 1 is a simplified block diagram illustrating an embodiment of the present invention.

FIG. 2 is a screener flow diagram in accordance with one embodiment of the present invention and including a home page, a screening page, and a plurality of tracks;

FIG. 3 is a screener flow diagram associated with the screening page of FIG. 2 and including an associated sub-screening page and a personal information form page;

FIG. 4 is a screener flow diagram associated with the sub-screening page of FIG. 3; and

FIG. 5 is a screener flow diagram associated with the personal information form page of FIGS. 3 and 4.

### DETAILED DESCRIPTION

While this invention is susceptible of embodiments in many different forms, there is shown in the drawings and will herein be described in detail a preferred embodiment of the invention. The present disclosure is to be considered as an exemplification of the principles of the invention and is not intended to limit the broad aspect of the invention to the embodiment illustrated.

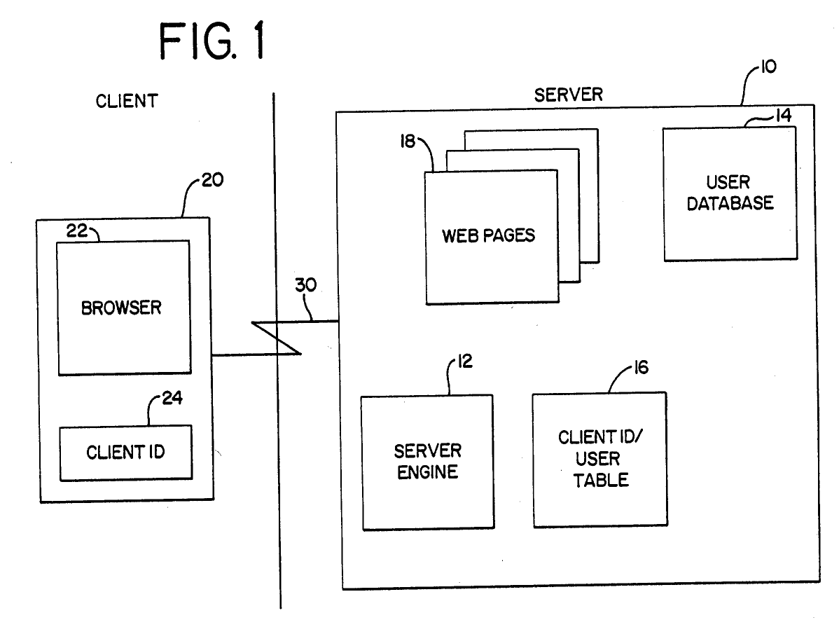

Referring now to the drawings, and in particular to FIG. 1, a simplified block diagram is provided illustrating an embodiment of the present invention. This embodiment supports providing user specific information over the Internet using the World Wide Web. The server system 10 includes a server engine 12, a user database 14, a client identifier/user table 16, and various Web pages 18. The server engine 12 receives HTTP requests to access Web pages 18 identified by URLs and provides the Web pages to the various client systems.

The user database 14 contains information for various users. The user information can include user-specific information such as the name of the user, personal information such as medical condition, and e-mail address. The client identifier/user table 16 contains a mapping from each client identifier, which is a globally unique identifier that uniquely identifies a client system, to the user last associated with that client system.

The client system 20 contains a browser 22 and its assigned client identifier 24. The client identifier is stored in a file and is typically referred to as a “cookie.” In one embodiment, the server system 10 assigns and sends the client identifier 24 to the client system once the client system interacts with the server system as described in detail further herein. From then on, the client system 20 includes its client identifier 24 with all messages sent to the server system 10 so that the server system can identity the source of the message. The server and client system interface by exchanging information via communication link 30 which can include transmission over the Internet.

One skilled in the art would appreciate that the present invention can also be used in various environments other than the Internet. For example, various communication channels may be used such as local area network, wide area network, or point-to-point dial up connections. Also, a server system can comprise any combination of hardware or software that can interact with the server system. These systems can include television-based systems or various other consumer products through which information may be retrieved.

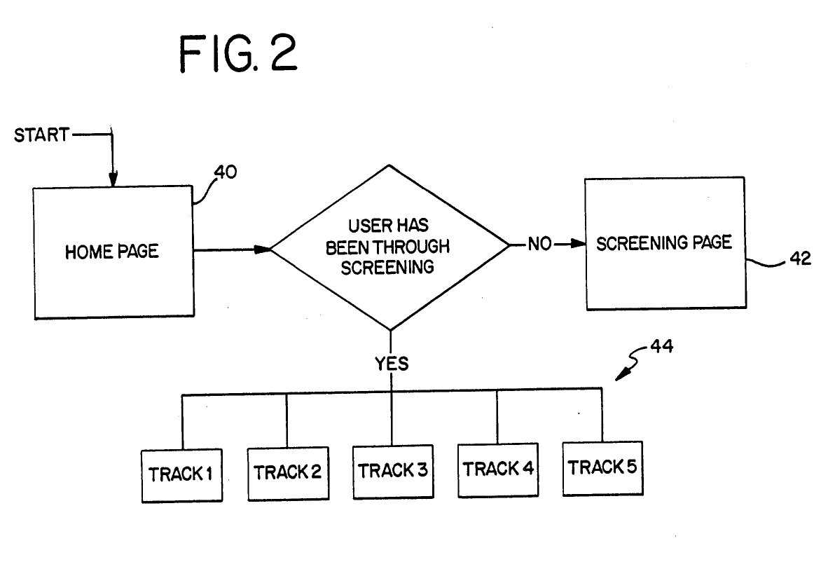

FIG. 2 is a screener flow diagram in accordance with one embodiment of the present invention and including a home page 40, a screening page 42, and a plurality of tracks 44. Preferably, the home page 40 is the first Web page sent from the server system 10 to the client system 20 whenever the user initially accesses the web site containing additional documents (e.g., Web pages 18) and identified by a specified address on the WWW.

The home page 40 can provide general information regarding the web site and hypertext links for taking a user of the client system 20 to other documents. In an embodiment, the home page 40 can provide a hypertext link for those users who have already visited the web site and another hypertext link for those users who are first time visitors of the web site.

Preferably, the home page 40 includes instructions for directing a user visiting the web site for the first time to click on the hypertext link taking the user to the screening page 42. The term “click” as used herein refers to tapping on the button of a device, such as a mouse, used to control the movement of a pointer on a display screen included in the client system 20. Also, the phrase “click on” as used herein refers to selecting the link by moving a mouse pointer to the link's position and clicking the mouse button.

As indicated above, the home page 40 also preferably includes instructions for directing a user who has already visited the web site to click on the link taking the user to one of the plurality of tracks 44. The particular track that the user is taken to is determined by the contents of the client identifier 24 (i.e., cookie), previously assigned to the client system 20 by the server system 10 if the user previously registered with the web site. As such, the client system 20 stores the assigned client identifier 24 in a text file and then sends the client identifier back to the server system 10 each time the browser 22 requests a Web page from the server. The client identifier, or cookie, is used to personally identify the user and direct the user to a specific track containing specific web pages that can be further customized by, for example, including the user's name on the Web pages.

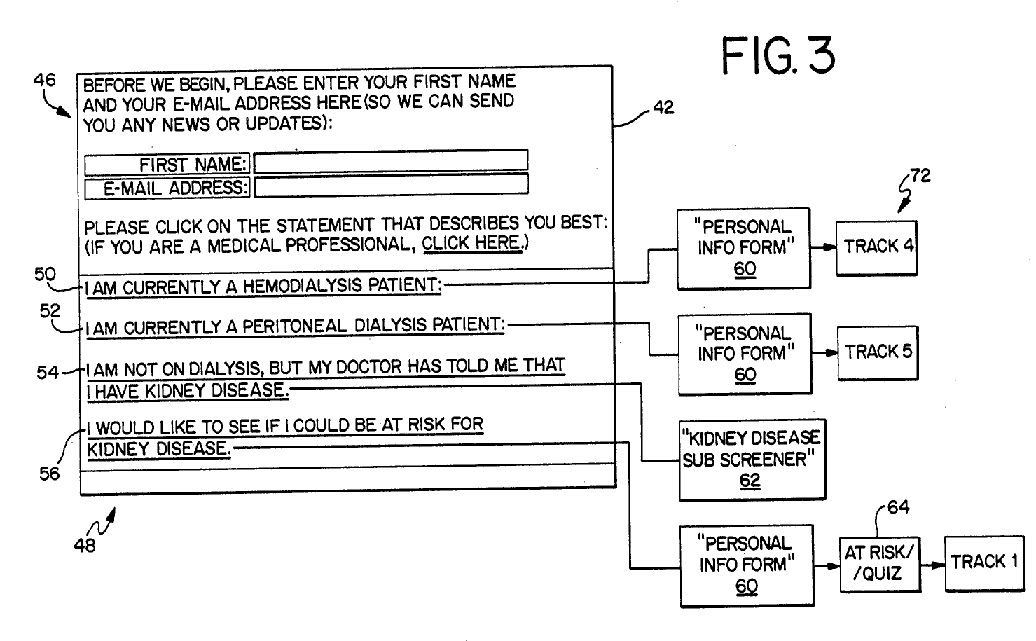

Turning to FIG. 3, the screening page 42 can contain questions 46 to be answered by the user for registering with the web site. For instance, the user may be requested to provide his or her name, e-mail address, and reason for visiting the web site. This information is provided to the server system 10 and stored in the user database 14. The user is then given a client identifier 24 after completing the personal information form 60. The client identifier is sent to the user's browser 24 which stores the cookie and, as previously explained above, the next time the same user goes to the web site, the browser will send the cookie to the server 10 for specifically identifying the user and thus directing the user to a specific track after the user visits the home page 40. Moreover, the e-mail information provided by the user can be used to provide recent news and updates regarding information that the user has indicated an interest in during screening.

The screening page 42 also preferably provides a list of statements 48, in the form of hypertext links, for inquiring into the user's current medical condition and reason for visiting the web site. By selecting one of the statements, by clicking on it, the user is moved to Web pages linked to the statement.

For example, by selecting statement 50, the user is moved to a personal information form page 60 and then track 4. By selecting statement 52, the user is moved to the personal information form page 60 and then track 5. By selecting statement 54, the user is moved to the sub-screening page 62. And by selecting statement 56, the user is moved to the personal information form page 60, a quiz page 64, and track 1, respectively.

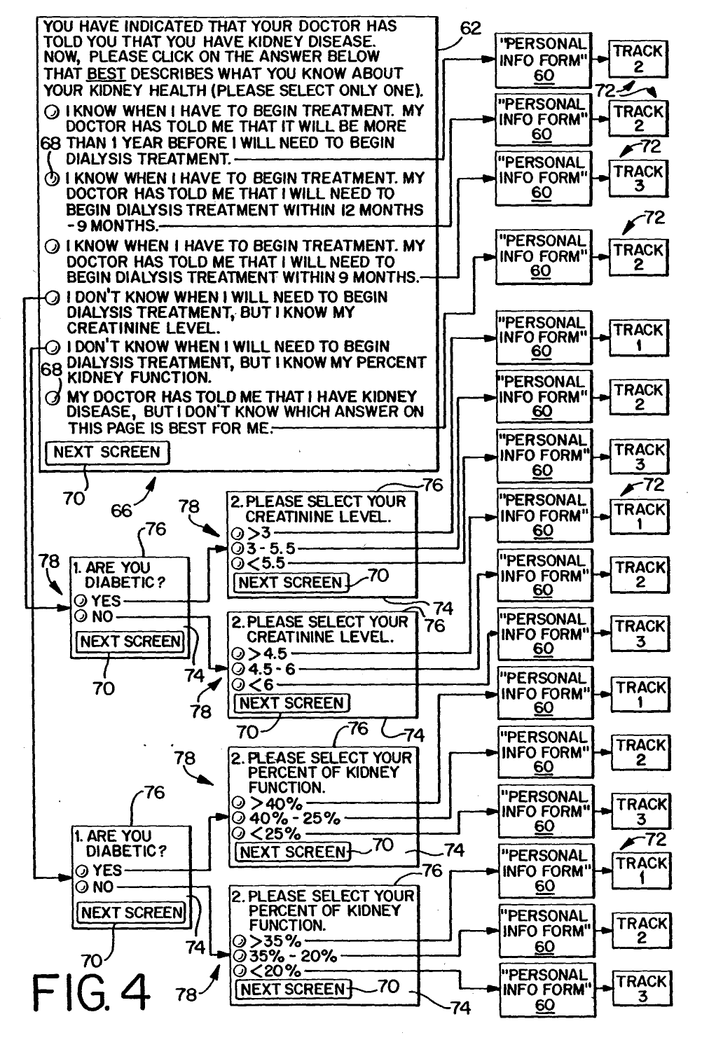

FIG. 4 depicts the sub-screening page 62 and other Web pages, or screens, linked to initial questions or statements 66 on page 62. In an embodiment, the statements 66 provide for inquiring further into the user's medical condition or diagnosis. The statements can be in the form of hypertext links or have individually associated radio buttons 68 wherein the user selects one button and, by selecting that button, all other buttons are automatically deselected. After selecting a button, the user is moved to an associated link by selecting a next screen button 70.

The links associated with the questions 66 on the sub-screening page 62 preferably comprise specific paths or branches 72 through the pages of the Web site, or additional question or decision screens 74 for further inquiry into the user's medical condition or diagnosis. These decision screens 74 can include additional questions or statements 76 and associated responses 78 to the questions or statements. The questions or statements 76 on the decision screens 74 are based on the response given by the user to the previous question or statement presented. Further, the responses 78 to the questions or statements are linked to another decision screen or a specific branch 72.

Preferably, the decision screens 74 ask the user whether he or she is a diabetic, creatinine levels, and percent of kidney function. As depicted in FIG. 4, once a user responds to all questions presented, the user will be assigned to a particular branch suitable for his or her current medical condition or diagnosis and based on the user's responses.

In an embodiment, each branch 72 first directs a user through the personal information form page 60 and then to a specific track dictated by the user's responses to questions or statements presented. Preferably, the form page 60 acts as gateway that the user must pass through, after screening, before the user is allowed to access a particular track. As indicated above, once the user completes the form page, the user's client system 20 is given a client identifier 24 by the server system 10 wherein, the next time the user goes to the web site, the browser will send the identifier to the server for specifically identifying the user and thus directing the user to a specific track after the user visits the home page 40 instead of the screening page 42.

As shown in FIG. 5, the personal information form page 60 can contain questions that the web site manager may have an interest in obtaining. For instance, the form page 60 can request information regarding how the user found the Web site and the user's country of origin.

The form page 60 includes hypertext links 80 and 82 wherein link 80 moves a user to either one of the tracks or the quiz page 64, and link 82 moves a user to a site map 90. Accordingly, by selecting link 82, the site map is displayed which provides descriptive phrases or terms, in the form of hypertext links, of various Web pages that a user can directly access by selecting the description.

Moreover, by selecting link 80, the user is moved to either the quiz page 64 or one of the tracks as determined by the user's previous responses to the questions presented to him or her. The quiz page 64 preferably provides a user with an idea of the conditions that can put him or her at risk for contracting a disease or medical condition, such as, kidney disease. Although not meant to replace the knowledge and diagnosis of a doctor, the quiz page presents questions to the user, and based on the user's responses, the user is provided with a Web page to assist in talking to a healthcare provider about contracting a disease or medical condition.

Turning to tracks 1-5, each track preferably provides information directed specifically for the user's medical condition as indicated by his or her responses to questions presented during screening. In an embodiment, each track is comprised of web pages providing specific articles, and insights from a healthcare professional guide, kidney patients, and caregivers related to the user's indicated medical condition.

For example, track 1 can consist of Web pages for assisting a user at risk for kidney disease to efficiently obtain information for understanding how the kidneys work, the symptoms of kidney disease, and ways to delay kidney problems. Moreover, track 1 can include an overview of the types of treatment available if the user's health changes, and links to articles for further reading.

Track 2 can consist of Web pages for a user who has been diagnosed with kidney disease, but will probably not start dialysis for at least another nine months. These Web pages can be designed to assist a user in taking care of his or her health, learning about the symptoms of advanced kidney disease, and learning about blood and urine tests that tell a doctor how well the kidneys are, or are not, functioning.

Likewise, Track 3 can consist of Web pages for a user who has been diagnosed with kidney disease, and will probably start dialysis within the next nine months. As such, these Web pages can be designed to assist a user in understanding how kidney failure comes about, understanding his or her blood tests, and details about treatment choices.

Moreover, Track 4 and Track 5 provide Web pages for users on hemodialysis and peritoneal dialysis, respectfully. For users on hemodialysis, the Web pages can include details about treatment choices and links to articles for further reading. Likewise, for users on peritoneal dialysis, the Web pages can include details about treatment choices and links to additional articles.

While the specific embodiments have been illustrated and described, numerous modifications come to mind without significantly departing from the spirit of the invention and the scope of protection is only limited by the scope of the accompanying claims.

We claim:

1. A method of providing specific information for a user comprising:
providing a server system having a plurality of tracks wherein each track includes a plurality of documents relating to a specific stage of a medical condition;
providing a client system having a browser and an identifier of the client system and one of the tracks;
sending the identifier to the server system; and,
sending the documents within one of the tracks to the client system in response to receiving the identifier, wherein the sent documents correspond to the track identified by the identifier.

2. The method of claim 1 further comprising the step of assigning the identifier to the user in response to one or more responses to medical questions provided by the user.

3. The method of claim 1 further comprising the step of providing e-mail to the client system in response to one or more responses to medical questions provided by the user.

4. The method of claim 1 wherein the documents within one of the tracks relate to being diagnosed with kidney disease.

5. The method of claim 4 wherein the documents within one of the tracks relate to being diagnosed with kidney disease and the user having more than about nine months before starting dialysis.

6. The method of claim 4 wherein the documents within one of the tracks relate to being diagnosed with kidney disease and the user having less than about nine months before starting dialysis.

7. The method of claim 4 wherein the documents within one of the tracks relate to hemodialysis treatment.

8. The method of claim 4 wherein the documents within one of the tracks relate to peritoneal dialysis treatment.

9. The method of claim 2 wherein at least one of the questions asks whether the user is a diabetic.

10. The method of claim 2 wherein at least one of the questions asks about the creatinine level of the user.

11. The method of claim 2 wherein at least one of the questions asks about the percent of kidney function of the user.

12. The method of claim 2 wherein one of the questions asks whether the user is a hemodialysis patient.

13. The method of claim 2 wherein one of the questions asks whether the user is a peritoneal dialysis patient.

14. A client system for providing a user with specific information comprising:
an identifier that identifies a client and one of a plurality of tracks, wherein each track contains documents relating to a specific stage of a diagnosed medical condition; and,
a browser for sending the identifier to a server system and displaying documents within the track identified by the identifier.

15. A server system for providing a user with specific information comprising:
a plurality of tracks wherein each track includes a plurality of documents relating to a specific stage of a medical condition; and,
a server for receiving an identifier that identifies a client system and one of the tracks, and sending the documents within one of the tracks to the client system in response to receiving the identifier, wherein the sent documents correspond to the track identified by the identifier.

16. The server system of claim 15 wherein the server engine assigns the identifier to the client system in response to one or more responses to medical questions provided by the user.

17. The server system of claim 15 wherein the documents within one of the tracks relate to being diagnosed with kidney disease.

18. The server system of claim 16 wherein at least one of the questions asks whether the user is a diabetic.

19. The server system of claim 16 wherein one of the questions asks whether the user is a hemodialysis patient.

20. The server system of claim 16 wherein one of the questions asks whether the user is a peritoneal dialysis patient.
